(19) United States
(12) Patent Application Publication
(10) Pub. No.: US 2021/0272041 A1
(43) Pub. Date: Sep. 2, 2021

(54) CORPORATE PERFORMANCE FORECAST MANAGEMENT SYSTEM AND METHOD

(71) Applicant: Hironobu KATOH, Tokyo (JP)

(72) Inventor: Hironobu KATOH, Tokyo (JP)

(21) Appl. No.: 17/252,159

(22) PCT Filed: Oct. 25, 2018
(86) PCT No.: PCT/JP2018/039685

§ 371 Date: Dec. 14, 2020

(51) Int. Cl. G06Q 10/06; G06Q 40/06

(52) U.S. Cl. CPC G06Q 10/06375; G06Q 40/06

(57) ABSTRACT

The present technology enables management of quarterly progress with respect to annual planned values of corporate performance and easy comparison with values predicted by a user during the same period.

The system is a system for managing forecast of corporate performance, and includes a server configured to store planned values of corporate performance in a first period, and a client configured to send, to the server, user's predicted values of corporate performance in a second period which is within the first period and shorter than the first period. The server is configured to calculate planned values of the corporate performance in the second period based on the planned values of the corporate performance in the first period, compare the planned values of the corporate performance in the second period with the user's predicted values of the corporate performance in the second period, and send an alert to the client when the planned values of the corporate performance in the second period and the user's predicted values of the corporate performance in the second period deviate from each other by a predetermined value or more.

### TECHNICAL FIELD

The present technology relates to a system and a method for managing forecasts of corporate performance.

### BACKGROUND ART

The following are the main recommended methods of dealing in stocks (issue) of a company.

### (1) Make a Judgment Based on Stock Price

For example, it is recommended to sell stocks when the absolute stock price is high, and buy stocks when the absolute stock price is low. In addition, it is recommended to sell stocks when the stock price rises significantly in a certain period of time, and buy stocks when the stock price falls significantly in a certain period of time.

### (2) Make a Judgment Based on Market Capitalization

For example, it is recommended to buy stocks when the market capitalization is undervalued than that of similar companies. In addition, if the stock is a small-cap stock with a small absolute market capitalization, it is recommended to buy stocks because there is room for increase, and if the stock is a large-cap stock with a large absolute market capitalization, it is recommended to sell stocks because there is little room for increase.

### (3) Make a Judgment Based on Forecasts Made by Analysts at Securities Companies or Research Companies

It is judged whether the stock is overvalued or undervalued based on an analyst's performance forecast. For example, it is recommended to buy stocks when an analyst in charge of electrical sector judges that Company A has a low stock price or market capitalization for its corporate performance.

In addition, a surprise is predicted based on the performance forecasts made by a specific analyst. For example, it is recommended to buy stocks when a specific analyst B judges that the performance of Company A exceeds the consensus achieved by an unspecified number of analysts compiled by NIKKEI QUICK® News, BLOOMBERG®, securities companies, research companies, and the like.

### (4) Recommended Basket

An unspecified number of issues in a particular theme or sector are recommended. For example, it is recommended to buy stocks of 30 artificial intelligence (AI) related companies as AI will grow in the future.

In addition, an unspecified number of issues extracted based on some indexes such as dividend payout ratio and return on equity (ROE) are recommended. For example, it is recommended to buy high dividend yield issues. However, the judgment is made based on the forecasts made by securities companies and research companies or figures of plan or results of listed companies.

### CITATION LIST

### Patent Literature

Patent Literature 1: Japanese Patent No. 6288662
Patent Literature 2: Japanese Patent Laid-Open No. 2007-264969
Patent Literature 3: Japanese Patent Laid-Open No. 2011-204199

### SUMMARY OF INVENTION

### Technical Problem

A system or method that can manage quarterly progress with respect to annual planned values of corporate performance and easily compare it with values predicted by a user during the same period is desired.

In addition, a system or method that can manage quarterly progress with respect to annual planned values of corporate performance and easily determine whether there is a significant difference from the values predicted by a user during the same period is desired.

Furthermore, a system or method is desired which facilitates estimation of the second quarter (Q2) or the second, third and fourth quarters (Q2, Q3, Q4) at the end of the first quarter (Q1) even if the planned values of corporate performance are disclosed only for “annual” or for “annual” and “first half” and are not disclosed quarterly.

In addition, a system or method that can easily determine whether or not there is a high possibility of “upward revision” or “downward revision” of corporate performance based on the progress of Q1 is desired.

In addition, a system or method that can easily determine that the corporate performance deviates from a user's expectation based on the progress of Q1 is desired.

In addition, a system or method that can objectively determine whether the planned values of corporate performance are bullish or bearish is desired.

In addition, a system or method that can easily determine the time when the planned values of corporate performance deviate significantly from a user's expectation is desired.

In addition, a system or method that allows fund managers who manage a large number of issues to easily manage corporate performance of each company is desired.

In addition, a system or method is desired which can manage progress of each year with respect to a medium-term plan or a long-term plan for corporate performance, for example, a management plan within the next 3 to 5 years, and easily compare it with the values predicted by a user during the same period.

In addition, a system or method that can estimate planned values after 1 year or 2 years even when only planned values after 3 years are disclosed in a medium-term plan for corporate performance is desired.

Furthermore, a system or method that can estimate planned values after 2 years even when only planned values after 3 years and planned values after 1 year (current term) are disclosed in a medium-term plan for corporate performance is desired.

### Solution to Problem

The present technology includes, for example, a corporate performance forecast management system which is a system for managing forecast of corporate performance and includes a server configured to store planned values of corporate performance in a first period, and a client configured to send, to the server, user's predicted values of corporate performance in a second period which is within the first period and shorter than the first period. The server is configured to calculate planned values of the corporate performance in the second period based on the planned values of the corporate performance in the first period, compare the planned values of the corporate performance in the second period with the user's predicted values of the corporate performance in the second period, and send an alert to the client when the planned values of the corporate performance in the second period and the user's predicted values of the corporate performance in the second period deviate from each other by a predetermined value or more.

### BRIEF DESCRIPTION OF DRAWINGS

FIG. 1 is a diagram showing a corporate performance forecast management system according to an embodiment of the present technology.

FIG. 2 is a flowchart showing a method for forecasting corporate performance according to an embodiment of the present technology.

### DESCRIPTION OF EMBODIMENTS

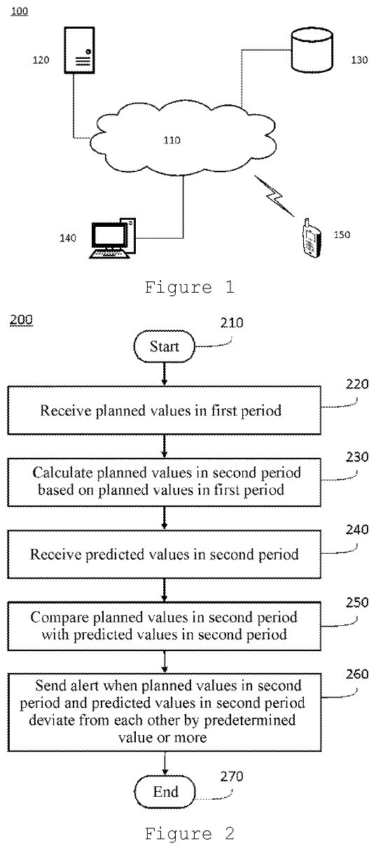

FIG. 1 shows a corporate performance forecast management system 100 according to an embodiment of the present technology.

The corporate performance forecast management system 100 includes a server 120, a storage device 130, and clients 140 and 150, all of which are connected to a network 110.

The network 110 connects a plurality of devices such as the server 120, the storage device 130, the clients 140 and 150, and the like in a communication-enabled manner. The network 110 may be the Internet, a local area network (LAN), or a wide area network (WAN). In addition, the network 110 may be wire-based, wireless or a combination of the two.

The server 120 is a computer having a processor (not shown), a memory that stores programs (not shown), and communication functions (not shown). The server 120 reads data via the network 110 or directly from the storage device 130 and writes data to the storage device 130. In addition, the server 120 executes the programs stored in the memory in response to the request from the client 140 or 150, and returns the result to the client 140 or 150.

The storage device 130 is a storage device accessible via the network 110 or directly from the server 120. The storage device 130 may be a network attached storage (NAS), or a hard disk drive (HDD) or a solid state drive (SSD) stored in the same enclosure as the server 120. The storage device 130 stores actual values and planned values of corporate performance. The actual values and the planned values of corporate performance may be received from the company, a stock exchange, or the like via the network 110. The storage device 130 may also store values of corporate performance predicted by a user.

The client 140 or 150 is a computer, tablet terminal, smartphone, or the like having a function of communicating with the server 120 via a wired Internet or a wireless Internet. The clients 140 and 150 are both depicted in FIG. 1. Alternatively, only one or more clients may be depicted.

FIG. 2 shows a corporate performance forecast management method 200 according to an embodiment of the present technology.

In FIG. 2, in step 210, the corporate performance forecast management method 200 is started in the server 120. Then, in step 220, the server 120 receives planned values of corporate performance in a first period from the storage device 130. The first period is, for example, one business year or one fiscal year (hereinafter collectively referred to as business year). For example, when a listed company discloses financial results, the content may be stored in the storage device 130 and transmitted to the server 120.

The planned values for corporate performance include, for example, planned values for a company's sustainable profits. The planned values for a company's sustainable profits includes planned values for at least one index of sales, operating revenue, gross profit, operating profit, ordinary profit, pre-tax profit, net profit, profit per share, earnings before interest and taxes (EBIT), earnings before interest, taxes, depreciation, and amortization (EBITDA), dividend amount, and the like. The server 120 may calculate one planned value of the multiple planned values of the company's sales, operating revenue, gross profit, operating profit, ordinary profit, pre-tax profit, net profit, and profit per share, or the planned values of other indexes by a method such as weighted average or the like. The planned values for a company's sustainable profits may be indexes specified in advance by the company or the industry to which the company belongs.

Next, in step 230, the server 120 calculates the planned values in the second period based on the planned values of the corporate performance in the first period (hereinafter, also simply referred to as planned values). The second period is a period within the first period and shorter than the first period. For example, if the first period is a business year, the second period may be half a year or a quarter in the business year. Furthermore, if the first period is a half year, the second period may be a quarter or a month in the half year. If the first period is a quarter, the second period may be one month or one week in the quarter.

The planned values in the second period may be calculated by prorating the planned values in the first period according to the period, or may be calculated by prorating the planned values in the first period according to the period and seasonality. Furthermore, the values prorated according to the period and seasonality may be prorated based on the seasonality of the performance of the company over the past several years.

Next, in step 240, the server 120 receives a user's predicted values of the corporate performance in the second period (hereinafter, simply referred to as predicted values) from the client 140 or 150. The predicted values may be the values predicted by the user, or the values selected by the user from a plurality of values predicted by third parties. Furthermore, the plurality of values predicted by the third parties may include the median value or the average value of the plurality of predicted values.

Then, in step 250, the server 120 compares the planned values in the second period with the predicted values in the second period.

Next, in step 260, the server 120 sends an alert when the planned values in the second period and the predicted values in the second period deviate from each other by a predetermined value or more.

The predetermined value may be a predetermined amount or a predetermined rate. The predetermined amount or the predetermined rate may be calculated using any of a standard deviation in the volatility of the performance of the company over the past several years, a fixed amount or rate, or a value or rate set by the user. The case of deviating by a predetermined value or more may include a case in which the difference between the predicted values and the planned values in two consecutive second periods changes from positive to negative or from negative to positive.

The alert may include the name or identification number of the company and information for specifying the second period. The alert indicates that the planned values and the predicted values of the company deviate from each other by a predetermined value or more in a specific period. Accordingly, if the user's forecast is correct, it will be a surprise for the market forecast, and the user can expect that the stock price of the company will change significantly around that period. The alert may be displayed as, for example, “target issue” or “recommended trading issue” and “target period”.

Next, in step 270, the corporate performance forecast management method 200 is completed.

Table 1 shows planned values and user's predicted values of performance of an enterprise (hereinafter, also referred to as company) at the beginning of the fiscal year according to an embodiment of the present technology. A detailed example is described below with reference to Table 1.

TABLE 1

| | | | FY18 (actual values) | | | | FY19 | | | |
|---|---|---|---|---|---|---|---|---|---|---|
| | FY18 | FY19 | Q1 | Q2 | Q3 | Q4 | Q1 | Q2 | Q3 | Q4 |
| (1) Sales (100 | 100 | | 19 | 21 | 29 | 31 | | | | |
| million yen) | | | | | | | | | | |
| (2) Sales YoY | | | 10% | 10% | 10% | 10% | | | | |
| (3) Company's planned | | 120 | | | | | 22.8 | 25.2 | 34.8 | 37.2 |
| sales (100 million | | | | | | | | | | |
| yen) | | | | | | | | | | |
| (4) Company's planned | | 20% | | | | | 20% | 20% | 20% | 20% |
| sales YoY | | | | | | | | | | |
| (5) User's predicted | | 115 | | | | | 25 | 25 | 30 | 35 |
| sales (100 million | | | | | | | | | | |
| yen) | | | | | | | | | | |
| (6) User's predicted | | 15% | | | | | 32% | 19% | 3% | 13% |
| sales YoY | | | | | | | | | | |
| (7) Deviation ((5)- | | | | | | | 2.2 | −0.2 | −4.8 | −2.2 |
| (3)) | | | | | | | | | | |
| (8) Operating profit | 20 | | 5 | 6 | 8 | 1 | | | | |
| (100 million yen) | | | | | | | | | | |
| (9) Operating profit | 20% | | 26% | 29% | 28% | 3% | | | | |
| margin | | | | | | | | | | |
| (10) Operating profit | 10% | | 10% | 10% | 10% | 10% | | | | |
| YoY | | | | | | | | | | |
| (11) Operating profit | | 30 | | | | | 5.7 | 6.3 | 8.7 | 9.3 |
| of company plan A | | | | | | | | | | |
| (100 million yen) | | | | | | | | | | |
| (12) Operating profit | | 25% | | | | | 25% | 25% | 25% | 25% |
| margin of company | | | | | | | | | | |
| plan A | | | | | | | | | | |
| (13) Operating profit | | 50% | | | | | 14% | 5% | 9% | 830% |
| YoY of company plan A | | | | | | | | | | |
| (14) Operating profit | | 5 | | | | | −1 | −4 | −3 | 22 |
| margin YoY (ppt) of | | | | | | | | | | |
| company plan A | | | | | | | | | | |
| (15) Operating profit | | 30 | | | | | 7.5 | 9 | 12 | 1.5 |
| of company plan B | | | | | | | | | | |
| (100 million yen) | | | | | | | | | | |
| (16) Operating profit | | 25% | | | | | 33% | 36% | 34% | 4% |
| margin of company | | | | | | | | | | |
| plan B | | | | | | | | | | |
| (17) Operating profit | | 50% | | | | | 50% | 50% | 50% | 50% |
| YoY of company plan B | | | | | | | | | | |
| (18) Operating profit | | 5 | | | | | 7 | 7 | 7 | 1 |
| margin YoY (ppt) of | | | | | | | | | | |
| company plan B | | | | | | | | | | |
| (19) Operating profit | | 30 | | | | | 7.1 | 8.5 | 11.3 | 3.1 |
| of company plan C | | | | | | | | | | |
| (100 million yen) | | | | | | | | | | |
| (20) Operating profit | | 25% | | | | | 31% | 34% | 33% | 8% |
| margin of company | | | | | | | | | | |
| plan C | | | | | | | | | | |
| (21) Operating profit | | 50% | | | | | 43% | 41% | 42% | 206% |
| YoY of company plan C | | | | | | | | | | |
| (22) Operating profit | | 5 | | | | | 5 | 5 | 5 | 5 |
| margin YoY (ppt) of | | | | | | | | | | |
| company plan C | | | | | | | | | | |
| (23) User's predicted | | 30.65 | | | | | 6.75 | 6.75 | 8.4 | 8.75 |
| operating profit (100 | | | | | | | | | | |
| million yen) | | | | | | | | | | |
| (24) User's predicted | | 27% | | | | | 27% | 27% | 28% | 25% |
| operating profit | | | | | | | | | | |
| margin | | | | | | | | | | |
| (25) User's predicted | | | | | | | 35% | 13% | 5% | 775% |
| operating profit YoY | | | | | | | | | | |

### (1) Sales (100 Million Yen)

Table 1 shows that the performance of last year (business year 2018, hereinafter also referred to as FY18) is disclosed at the beginning of the current year (business year 2019, hereinafter also referred to as FY19), the actual value of sales in FY18 is 10 billion yen, and the sales in the first to fourth quarters (hereinafter referred to as Q1 to Q4, etc.) are 1.9 billion yen, 2.1 billion yen, 2.9 billion yen, and 3.1 billion yen, respectively. These values are disclosed, for example, in the financial results submitted by the enterprise (hereinafter, also referred to as the company).

### (2) Sales YoY (Year on Year)

Table 1 shows that the sales of Q1 to Q4 in FY18 increased by 10% compared to the same period of the previous year (hereinafter also referred to as YoY). These values are disclosed in, for example, the financial results or the like.

### (3) Company's Planned Sales (100 Million Yen)

Table 1 shows that the company's planned sales in FY19 are 12 billion yen. This value is disclosed in, for example, the financial results or the like. The company's planned sales for each quarter of the current year are usually not disclosed, and thus may be allocated by the server 120 so that the sales for each quarter are even, or the sales for each quarter are evenly distributed year-on-year, or may be allocated based on the seasonality of the enterprise in the past few years (for example, 5 years). In addition, the company's planned sales for each quarter of the current year may be distributed by the user in any manner. If the company plan for each quarter is disclosed, it may be displayed with priority. In Table 1, the company's planned sales of Q1 to Q4 for the current year are allocated so that the year-on-year rate of change in sales for each quarter is 20% as shown in (4), and are calculated to be 2.28 billion yen, 2.52 billion yen, 3.48 billion yen, and 3.72 billion yen, respectively.

### (4) Company Plan YoY

The sales YoY in FY19 is calculated to be +20% from (1) and (3). As described above, the sales YoY is allocated to each quarter in FY19 so that the year-on-year rates of change in sales are even, and each is calculated to be +20%.

### (5) User's Predicted Sales (100 Million Yen)

The user's predicted values of sales in Q1 to Q4 in FY19 are received from the client 140 or 150 to the server 120, and are set to 2.5 billion yen, 2.5 billion yen, 3 billion yen, and 3.5 billion yen, respectively. By summing up these values, the predicted value of sales in FY19 is calculated to be 11.5 billion yen. The predicted value in FY19 may not be calculated. Alternatively, the user may predict sales in FY19 and allocate it to each quarter.

### (6) User's Predicted Sales YoY

The user's predicted sales YoY of Q1 to Q4 in FY19 are calculated to be +32%, +19%, +3%, and +13%, respectively. When the predicted value of sales in FY19 is calculated, the user's predicted sales YoY in FY19 may be calculated to be +15%.

Moreover, in (5) and (6), YoY may be predicted by the user instead of the sales, and the user's predicted sales may be calculated from the YoY.

### (7) Deviation ((5)-(3))

The deviation is calculated by comparing (5) user's predicted sales and (3) company's planned sales for each quarter in FY19 by the server 120. The deviation may be the difference between the user's predicted sales and the company's planned sales, the ratio of the user's predicted sales and the company's planned sales, an absolute value of the difference or ratio, or a square of the difference or ratio. In Table 1, the difference between the user's predicted sales and the company's planned sales ((5)-(3)) is calculated as the deviation value, and the deviation values for each quarter are calculated to be 220 million yen, −20 million yen, −480 million yen and −220 million yen, respectively.

Here, the deviation value changes from positive to negative, specifically from 220 million yen to −20 million yen from Q1 to Q2. The reason is considered that, for example, the user's predicted value of Q1 is bullish with respect to the company's planned value, while the user's predicted value of Q2 changes bearishly with respect to the company's planned value. In this case, the server 120 may determine that the user's predicted values deviate by a predetermined value or more, and send an alert to the client 140 or 150 to notify that the stock price is expected to change in Q2. The same applies when the deviation value changes from negative to positive. In addition, in Q3, the deviation value reaches a relatively large value of −480 million yen. The reason is that, for example, the user's predicted value in Q3 is significantly bearish with respect to the company's planned value. In this case, by setting the threshold value to an appropriate value (for example, 300 million yen), the server 120 may determine that the absolute value of the deviation value in Q3 is equal to or more than the predetermined value, and send an alert to the client 140 or 150 to notify that the stock price is expected to change in Q3. The same applies when the user's predicted values are significantly bullish with respect to the company's planned values.

### (8) Operating Profit (100 Million Yen)

The planned values and the predicted values may be obtained for operating profit. Table 1 shows that the actual operating profit in FY18 is 2 billion yen and the sales of Q1 to Q4 are 500 million yen, 600 million yen, 800 million yen, and 100 million yen, respectively. These values are disclosed in, for example, the financial results.

### (9) Operating Profit Margin ((8)/(1))

The operating profit margin is calculated by dividing (8) operating profit by (1) sales. The actual operating profit margin in FY18 is 20%, and the operating profit margins of Q1 to Q4 are calculated to be 26%, 29%, 28%, and 3%, respectively.

### (10) Operating Profit Margin YoY

Table 1 shows that the operating profit margins YoY of Q1 to Q4 in FY18 are all +10%.

### (11) Operating Profit of Company Plan a (100 Million Yen)

Tables 1 shows that the operating profit of the company plan according to the first example in FY19 (hereinafter, referred to as company plan A) is 3 billion yen. This value is disclosed in, for example, the financial results. The company's planned operating profits for each quarter of the current year are usually not disclosed, and thus may be allocated by the server 120 so that the sales for each quarter are even, or the sales for each quarter are evenly distributed year-on-year, or may be allocated based on the seasonality of the enterprise in the past few years (for example, 5 years). In addition, the company's planned operating profits for each quarter of the current year may be distributed by the user in any manner. In Table 1, as shown in (12), the operating profits of company plan A of Q1 to Q4 for the current year are allocated by the server 120 so that the year-on-year rate of change in sales for each quarter is 25%, and are calculated to be 570 million yen, 630 million yen, 870 million yen, and 930 million yen, respectively.

### (12) Operating Profit Margin of Company Plan A

The operating profit margin of company plan A is calculated by dividing (11) the operating profit of company plan A by (3) the company's planned sales. The operating profit margin of company plan A in FY19 is 25%, and the operating profit margins of Q1 to Q4 allocated by the server 120 are all 25%.

### (13) Operating Profit YoY of Company Plan A

The operating profit YoY of company plan A is calculated by comparing (8) operating profit and (11) operating profit of company plan A. The operating profit YoY of company plan A in FY19 is +50%, and the operating profits YoY of Q1 to Q4 are calculated to be +14%, +5%, +9%, and +830%, respectively.

Here, in Q4, the operating profit changes significantly to +830%. The reason is considered that a significant increase in profit is planned in Q4 or the value is an outlier. In this case, the planned value allocated to each quarter may be used as the predicted value, and the server 120 may determine that the predicted value deviates from the values in other quarters by a predetermined value or more and send an alert to the client 140 or 150 to notify that the stock price is expected to change in Q4 or the value is an outlier.

### (14) Operating Profit Margin YoY of Company Plan A

The operating profit margin YoY of company plan A is calculated in percentage point (hereinafter also referred to as ppt) by comparing (12) operating profit margin of company plan A and (9) operating profit margin. The operating profit margin YoY of company plan A in FY19 is (25%−20%=)+5 ppt, and the operating profit margins YoY of Q1 to Q4 are calculated to be −1 ppt, −4 ppt, −3 ppt, and +22 ppt, respectively.

Here, the operating profit margin YoY of company plan A in Q4 reaches a relatively large value of +22 ppt. The reason is considered that a significant increase in operating profit margin is planned in Q4 or the value is an outlier. In this case, the operating profit margins allocated to each quarter may be used as the predicted values, and the server 120 may determine that the predicted value deviates from the value in the same period of the previous year by a predetermined value (for example, 6 ppt) or more and send an alert to the client 140 or 150 to notify that the stock price is expected to change in Q4 or the value is an outlier.

### (15) Operating Profit of Company Plan B (100 Million Yen)

Tables 1 shows that the operating profit of the company plan according to the second example in FY19 (hereinafter, referred to as company plan B) is 3 billion yen. This value is disclosed in, for example, the financial results. The company's planned operating profits for each quarter of the current year are usually not disclosed, and thus may be allocated by the server 120 so that the operating profits for each quarter are even, or the operating profits for each quarter are evenly distributed year-on-year, or may be allocated based on the seasonality of the enterprise in the past few years (for example, 5 years). In addition, the company's planned operating profits for each quarter of the current year may be distributed by the user in any manner. In Table 1, the operating profits of company plan B of Q1 to Q4 for the current year are allocated by the server 120 so that the year-on-year rate of change in operating profit for each quarter is 50%, and are calculated to be 750 million yen, 900 million yen, 1.2 billion yen, and 150 million yen, respectively.

### (16) Operating Profit Margin of Company Plan B

The operating profit margin of company plan B is calculated by dividing (15) operating profit of company plan B by (3) company's planned sales. The operating profit margin of company plan B in FY19 is 25%, and the operating profit margins of Q1 to Q4 are calculated by the server 120 and are 33%, 36%, 34%, and 4%, respectively.

### (17) Operating Profit YoY of Company Plan B

The operating profit YoY of company plan B is calculated by comparing (8) operating profit and (15) operating profit of company plan B. The operating profit YoY of company plan B in FY19 is +50%, and the operating profits YoY of Q1 to Q4 are all +50%.

### (18) Operating Profit Margin YoY of Company Plan B

The operating profit margin YoY of company plan A is calculated in percentage point by comparing (16) operating profit margin of company plan B and (9) operating profit margin. The operating profit margin YoY of company plan A in FY19 is +5 ppt, and the operating profit margins YoY of Q1 to Q4 are calculated to be +7 ppt, +7 ppt, +7 ppt, and +1 ppt, respectively.

Here, the operating profit margin YoY of company plan A in Q1 reaches a relatively large value of +7 ppt. The reason is considered that an increase in operating profit margin is planned in Q1. In this case, the operating profit margin allocated to each quarter may be used as the predicted value, and the server 120 may determine that the predicted value deviates from the value in the same period of the previous year by a predetermined value (for example, 6 ppt) or more and send an alert to the client 140 or 150 to notify that the stock price is expected to change in Q4. Moreover, when the operating profit margin YoY of company plan A reaches a relatively large value of +7 ppt in Q2 and Q3, the server 120 may send an alert in the same manner as in Q1, or may not send an alert because the change from the previous quarter is not large enough.

### (19) Operating Profit of Company Plan C (100 Million Yen)

Tables 1 shows that the operating profit of the company plan according to the third example in FY19 (hereinafter, referred to as company plan C) is 3 billion yen. This value is disclosed in, for example, the financial results. The company's planned operating profits for each quarter of the current year are usually not disclosed, and thus may be allocated by the server 120 so that the operating profits for each quarter are even, or the operating profits for each quarter are evenly distributed year-on-year, or may be allocated based on the seasonality of the enterprise in the past few years (for example, 5 years). In addition, the company's planned operating profits for each quarter of the current year may be distributed by the user in any manner. In Table 1, the operating profits of company plan C of Q1 to Q4 for the current year are allocated by the server 120 so that the year-on-year rate of change in operating profit margin for each quarter is +5 ppt, and are calculated to be 710 million yen, 850 million yen, 1.13 billion yen, and 310 million yen, respectively.

### (20) Operating Profit Margin of Company Plan C

Similar to (12) and (16), the operating profit margin of company plan C in FY19 is 25%. In addition, as described above, the operating profits of company plan C of Q1 to Q4 for the current year are allocated so that the year-on-year rate of change in operating profit margin for each quarter is 5 ppt, and thus the operating profit margin of company plan C can be calculated by adding 5 ppt to (9) operating profit margin. The operating profit margins of Q1 to Q4 are calculated to be 31%, 34%, 33%, and 8%, respectively. Furthermore, by multiplying these values by (3) company's planned sales, the operating profits of company plan C of Q1 to Q4 are calculated to be 710 million yen, 850 million yen, 1.13 billion yen, and 310 million yen, respectively.

### (21) Operating Profit YoY of Company Plan C

Similar to (13) and (17), the operating profit YoY of company plan C in FY19 is 50%, and the operating profit YoY of company plan C is calculated by comparing (8) operating profit and (19) operating profit of company plan C. The operating profit YoY of company plan C in FY19 is +50%, and the operating profit YoY of Q1 to Q4 are calculated to be +43%, +41%, +42%, and +206%, respectively.

### (22) Operating Profit Margin YoY of Company Plan C

The operating profit margin YoY of company plan C is calculated in percentage point by comparing (20) operating profit margin of company plan C and (9) operating profit margin. In this example, as described above, the operating profit margin YoY of company plan A in FY19 is +5 ppt, and the operating profit margins YoY of Q1 to Q4 are all +5 ppt.

### (23) User's Predicted Operating Profit (100 Million Yen)

As described later in (24), the predicted value of operating profit margin for each quarter in FY19 is received from the client 140 or 150 to the server 120, and the user's predicted operating profits are calculated from (5) user's predicted sales and (24) user's predicted operating profit margin and are 675 million yen, 675 million yen, 840 million yen, and 875 million yen, respectively. By summing up these values, the predicted value of sales in FY19 is calculated to be 3.065 billion yen. The predicted operating profits in FY19 may not be calculated.

### (24) User's Predicted Operating Profit Margin

The user's predicted operating profit margins for each quarter in FY19 are received from the client 140 or 150 to the server 120 and set to 27%, 27%, 28% and 25%, respectively. In addition, the user's predicted operating profit margin in FY19 is calculated to be 27% by dividing (23) user's predicted operating profit in FY19 by (5) user's predicted sales. The user's predicted operating profit margins in FY19 may not be calculated.

### (25) User's Predicted Operating Profit Margin YoY

The user's predicted operating profit YoY is calculated by comparing (8) operating profit and (23) user's predicted operating profit. The user's predicted operating profits YoY of Q1 to Q4 are calculated to be +35%, +13%, +5%, and +775%, respectively.

Table 2 shows planned values and user's predicted values of corporate performance at the end of Q1 according to an embodiment of the present technology. A detailed example is described below with reference to Table 2. Moreover, the description of the parts common to Table 1 is omitted.

TABLE 2

| | | | FY18 (actual values) | | | | FY19 | | | |
|---|---|---|---|---|---|---|---|---|---|---|
| | FY18 | FY19 | Q1 | Q2 | Q3 | Q4 | Q1 | Q2 | Q3 | Q4 |
| (1) Sales (100 | 100 | | 19 | 21 | 29 | 31 | 21 | | | |
| million yen) | | | 10% | 10% | 10% | 10% | 11% | | | |
| (2) Sales YoY | | | | | | | | | | |
| (3) Company's planned | | 120 | | | | | | 25.7 | 35.4 | 37.9 |
| sales (100 million | | | | | | | | | | |
| yen) | | | | | | | | | | |
| (4) Company's planned | | 20% | | | | | | 22% | 22% | 22% |
| sales YoY | | | | | | | | | | |
| (5) User's predicted | | 115 | | | | | 25 | 25 | 30 | 35 |
| sales (100 million | | | | | | | | | | |
| yen) | | | | | | | | | | |
| (6) User's predicted | | 15% | | | | | 32% | 19% | 3% | 13% |
| sales YoY | | | | | | | | | | |
| (7) Deviation ((5)- | | | | | | | | −0.7 | −5.4 | −2.9 |
| (3)) | | | | | | | | | | |
| (8) Operating profit | 20 | | 5 | 6 | 8 | 1 | | | | |
| (100 million yen) | | | | | | | | | | |
| (9) Operating profit | 20% | | 26% | 29% | 28% | 3% | | | | |
| margin | | | | | | | | | | |
| (10) Operating profit | | | 10% | 10% | 10% | 10% | | | | |
| YoY | | | | | | | | | | |
| (11) Operating profit | | 30 | | | | | 4.5 | 6.6 | 9.1 | 9.8 |
| of company plan A | | | | | | | | | | |
| (100 million yen) | | | | | | | | | | |
| (12) Operating profit | | 25% | | | | | 21% | 26% | 26% | 26% |
| margin of company | | | | | | | | | | |
| plan A | | | | | | | | | | |
| (13) Operating profit | | 50% | | | | | −10% | 10% | 14% | 876% |
| YoY of company plan A | | | | | | | | | | |
| (14) Operating profit | | 5 | | | | | −5 | −3 | −2 | 23 |
| margin YoY of | | | | | | | | | | |
| company plan A (ppt) | | | | | | | | | | |
| (15) Operating profit | | 30 | | | | | 4.5 | 10.2 | 13.6 | 1.7 |
| of company plan B | | | | | | | | | | |
| (100 million yen) | | | | | | | | | | |
| (16) Operating profit | | 25% | | | | | 21% | 40% | 38% | 4% |
| margin of company | | | | | | | | | | |
| plan B | | | | | | | | | | |
| (17) Operating profit | | 50% | | | | | −10% | 70% | 70% | 70% |
| YoY of company plan B | | | | | | | | | | |
| (18) Operating profit | | 5 | | | | | −5 | 11 | 11 | 1 |
| margin YoY of | | | | | | | | | | |
| company plan B (ppt) | | | | | | | | | | |
| (19) Operating profit | | 30 | | | | | 4.5 | 9.2 | 12.3 | 4.0 |
| of company plan C | | | | | | | | | | |
| (100 million yen) | | | | | | | | | | |
| (20) Operating profit | | 25% | | | | | 21% | 36% | 35% | 10% |
| margin of company | | | | | | | | | | |
| plan C | | | | | | | | | | |
| (21) Operating profit | | 50% | | | | | −10% | 53% | 54% | 297% |
| YoY of company plan C | | | | | | | | | | |
| (22) Operating profit | | 5 | | | | | −5 | 7 | 7 | 7 |
| margin YoY of | | | | | | | | | | |
| company plan C (ppt) | | | | | | | | | | |
| (23) User's predicted | | 30.65 | | | | | 6.75 | 6.75 | 8.4 | 8.75 |
| operating profit (100 | | | | | | | | | | |
| million yen) | | | | | | | | | | |
| (24) User's predicted | | 27% | | | | | 27% | 27% | 28% | 25% |
| operating profit | | | | | | | | | | |
| margin | | | | | | | | | | |
| (25) User's predicted | | | | | | | 35% | 13% | 5% | 775% |
| operating profit YoY | | | | | | | | | | |

### (1) Sales (100 Million Yen)

Table 2 shows that the sales of Q1 are 2.1 billion yen at the time of the disclosure of the results of Q1 in FY19. This value is disclosed in, for example, the financial results.

### (2) Sales YoY

Table 2 shows that the sales YoY of Q1 is +11% at the time of the disclosure of the results of Q1 in FY19. This value is disclosed in, for example, the financial results.

### (3) Company's Planned Sales (100 Million Yen)

The sales of Q1 are 2.1 billion yen and the company's planned sales in FY19 are 12 billion yen as long as it is not revised at the time of the disclosure of the results of Q1 in FY19, and therefore the company's planned sales of Q2 to Q4 are 9.9 billion yen. In Table 2, the company's planned sales of Q2 to Q4 for the current year are allocated by the server 120 with reference to (4) so that the year-on-year rate of change in sales for each quarter is 22%, and are calculated to be 2.57 billion yen, 3.54 billion yen, and 3.79 billion yen, respectively.

### (4) Company Plan YoY

As described above, the company's planned sales of Q2 to Q4 are 9.9 billion yen, and the sales of Q2 to Q4 in FY18 are 8.1 billion yen from (1), and therefore the YoY of Q2 to Q4 is calculated to be +22%. The year-on-year rates of change in sales are evenly allocated to Q2 to Q4 in FY19, and each is +22%.

### (5) User's Predicted Sales (100 Million Yen)

The user's predicted sales of Q2 to Q4 in FY19 are not changed at the time of the disclosure of the results of Q1 in FY19.

### (6) User's Predicted Sales YoY

Along with (5), the user's predicted sales YoY of Q2 to Q4 in FY19 are not changed either.

### (7) Deviation ((5)-(3))

The user's predicted sales of Q2 to Q4 in FY19 and the company's planned sales are compared by the server 120, and the deviation is calculated. The deviation values from Q2 to Q4 are calculated to be −70 million yen, −540 million yen, and −290 million yen, respectively.

Here, in Q3, the deviation value reaches a relatively large value of −540 million yen. The reason is considered that, for example, the predicted value in Q3 is significantly bearish with respect to the planned value. In this case, by setting the threshold value to an appropriate value (for example, 300 million yen), the server 120 may determine that the absolute value of the deviation value in Q3 is equal to or more than the predetermined value and send an alert to the client 140 or 150 to notify that the stock price is expected to change in Q3.

### (8) Operating Profit (100 Million Yen)

The operating profits are the same as in Table 1.

### (9) Operating Profit Margin ((8)/(1))

The operating profit margins are the same as in Table 1.

### (10) Operating Profit Margin YoY

The operating profit margins YoY are the same as in Table 1.

### (11) Operating Profit of Company Plan a (100 Million Yen)

Table 2 shows that the operating profit of Q1 is 450 million yen at the time of the disclosure of the results of Q1 in FY19. This value is disclosed in, for example, the financial results. The operating profit of company plan A in FY19 is 3 billion yen as long as it is not revised, and therefore the operating profit of company plan A in Q2 to Q4 is 2.55 billion yen. In Table 2, the operating profits of company plan A in Q2 to Q4 of the current year are allocated by server 120 with reference to (12) so that the year-on-year rates of change in sales of Q2 to Q4 are all 26%, and are calculated to be 660 million yen, 910 million yen, and 980 million yen, respectively.

### (12) Operating Profit Margin of Company Plan A

The operating profit margin of company plan A is calculated to be 21% by dividing (11) operating profit of 450 million yen in Q1 by (1) sales of 2.1 billion yen in Q1 at the time of the disclosure of the results of Q1 in FY19. In addition, the above-mentioned operating profit of 2.55 billion yen in Q2 to Q4 divided by (3) company's planned sales of 9.9 billion yen in Q2 to Q4 is 26%, and this value is evenly allocated to Q2 to Q4, and thus the operating profit margins of company plan A of Q2 to Q4 are all 26%.

### (13) Operating Profit YoY of Company Plan A

The operating profit YoY of company plan A is calculated by comparing (8) operating profit and (11) operating profit of company plan A at the time of the disclosure of the results of Q1 in FY19. The operating profits YoY of Q1 to Q4 are calculated to be −10%, +10%, +14%, and +876%, respectively.

Here, the YoY reaches an extremely large value of 876% in Q4. The reason is considered that a significant increase in profits is planned in Q4 or the value is an outlier. In this case, the planned value allocated to each quarter may be used as the predicted value, and the server 120 may determine that the predicted value deviates by a predetermined value or more and send an alert to the client 140 or 150 to notify that the stock price is expected to change significantly in Q4 or the value is an outlier.

### (14) Operating Profit Margin YoY of Company Plan A

The operating profit margin YoY of company plan A is calculated in percentage point by comparing (12) operating profit margin of company plan A and (9) operating profit margin. The operating profit margin YoY of company plan A in FY19 is +5 ppt, and the operating profit margins YoY of Q1 to Q4 are calculated to be −5 ppt, −3 ppt, −2 ppt, and +23 ppt, respectively.

Here, the operating profit margin YoY of company plan A reaches a relatively large value of +22 ppt in Q4. The reason is considered that a significant increase in the operating profit margin is planned in Q4 or the value is an outlier. In this case, the operating profit margin allocated to each quarter may be used as the predicted value, and the server 120 may determine that the predicted value deviates from the value in the same period of the previous year by a predetermined value (for example, 6 ppt) or more and send an alert to the client 140 or 150 to notify that the stock price is expected to change in Q4 or the value is an outlier.

### (15) Operating Profit of Company Plan B (100 Million Yen)

Table 2 shows that the operating profit of Q1 is 450 million yen at the time of the disclosure of the results of Q1 in FY19. This value is disclosed in, for example, the financial results. The operating profit of company plan B in FY19 is 3 billion yen as long as it is not revised, and therefore the operating profit of company plan B of Q2 to Q4 is 2.55 billion yen. In Table 2, the operating profits of company plan B of Q2 to Q4 for the current year are allocated by server 120 with reference to (17) so that the year-on-year rates of change in operating profit of Q2 to Q4 are all 70%, and are calculated to be 1.02 billion yen, 1.36 billion yen, and 170 million yen, respectively.

### (16) Operating Profit Margin of Company Plan B

The operating profit margin of company plan B is calculated to be 21% by dividing (11) operating profit of 450 million yen in Q1 by (1) sales of 2.1 billion yen in Q1 at the time of disclosure of the results of Q1 in FY19. In addition, the operating profit margins of Q2 to Q4 are calculated to be 40%, 38%, and 4%, respectively, by comparing (3) company's planned sales and (15) operating profits of company plan B in Q2 to Q4.

### (17) Operating Profit YoY of Company Plan B

The operating profit YoY of company plan B is calculated by comparing (8) operating profit and (15) operating profit of company plan B. The operating profit of 2.55 billion yen in Q2 to Q4 mentioned above divided by the operating profit of 1.5 billion yen in Q2 to Q4 in FY18 is +70% at the time of the disclosure of the results of Q1 in FY19, and this value is evenly allocated to Q2 to Q4, and thus the operating profits YoY of company plan B are all +70%.

### (18) Operating Profit Margin YoY of Company Plan B

The operating profit margin YoY of company plan B is calculated in percentage point by comparing (16) operating profit margin of company plan B and (9) operating profit margin. The operating profit margin YoY of company plan B in FY19 is +5 ppt, and the operating profit margins YoY of Q1 to Q4 are calculated to be −5 ppt, +11 ppt, +11 ppt, and +1 ppt, respectively.

Here, the operating profit margin YoY of company plan B reaches a relatively large value of +11 ppt in Q2. The reason is considered that an increase in the operating profit margin is planned in Q2. In this case, the operating profit margin allocated to each quarter may be used as the predicted value, and the server 120 may determine that the predicted value deviates from the value in the same period of the previous year by a predetermined value (for example, 6 ppt) or more and send an alert to the client 140 or 150 to notify that the stock price is expected to change in Q2. The same applies to Q3 and Q4.

In addition, the operating profit margin YoY changed from negative to positive, specifically from −5 ppt to +7 ppt from Q1 to Q2. In this case, the server 120 may determine that the operating profit margin deviates by the predetermined value or more and send an alert to the client 140 or 150 to notify that the stock price is expected to change in Q2. The same applies to the case of changing from positive to negative.

### (19) Operating Profit of Company Plan C (100 Million Yen)

Table 2 shows that the operating profit of Q1 is 450 million yen at the time of the disclosure of the results of Q1 in FY19. This value is disclosed in, for example, the financial results. The operating profit of company plan C in FY19 is 3 billion yen as long as it is not revised, and therefore the operating profit of company plan C in Q2 to Q4 is 2.55 billion yen. The operating profit margin of Q2 to Q4 is calculated to be 26% based on the operating profit of company plan C in Q2 to Q4 and (3) company's sales. On the other hand, the operating profit margin of Q2 to Q4 in FY18 is calculated to be 19% based on (1) sales and (8) operating profit. In this example, as described later in (20), the operating profits of company plan C of Q2 to Q4 for the current year are allocated by the server 120 so that the year-on-year rates of change in operating profit of Q2 to Q4 are all (26-19=)+7 ppt, and are calculated to be 920 million yen, 1.23 billion yen, and 400 million yen, respectively.

### (20) Operating Profit Margin of Company Plan C

Similar to (12) and (16), the operating profit margin of company plan C is calculated to be 21% at the time of the disclosure of the results in Q1 in FY19. As described above, the operating profits of company plan C of Q2 to Q4 for the current year are allocated so that the year-on-year rate of change in the operating profit margin for each quarter is +7 ppt, and thus the operating profit margin of company plan C can be calculated by adding 7 ppt to (9) operating profit margin. The operating profit margins of Q2 to Q4 are calculated to be 36%, 35%, and 10%, respectively. Furthermore, the operating profits of company's plan C in Q1 to Q4 are calculated to be 920 million yen, 1.23 billion yen, and 400 million yen, respectively, by multiplying the operating profit margins of Q2 to Q4 by (3) company's planned sales.

### (21) Operating Profit YoY of Company Plan C

The operating profit YoY of company plan C is calculated by comparing (8) operating profit and (19) operating profit of company plan C. The operating profits YoY of company plan C in Q2 to Q4 are calculated to be +53%, +54%, and +297%, respectively, at the time of the disclosure of the results of Q1 in FY19.

### (22) Operating Profit Margin YoY of Company Plan C

The operating profit margin YoY of company plan C is calculated in percentage point by comparing (20) operating profit margin of company plan C and (9) operating profit margin. As described above, the operating profit margins YoY of Q2 to Q4 are all +7 ppt.

### (23) User's Predicted Operating Profit (100 Million Yen)

The User's predicted operating profits of Q2 to Q4 in FY19 are not changed at the time of the disclosure of the results of Q1 in FY19.

### (24) User's Predicted Operating Profit Margin

The user's predicted operating profit margins of Q2 to Q4 in FY19 are not changed at the time of the disclosure of the results of Q1 in FY19.

### (25) User's Predicted Operating Profit Margin YoY

The user's predicted operating profit margins YoY of Q2 to Q4 in FY19 are not changed at the time of the disclosure of the results of Q1 in FY19.

The user's forecast is not limited to the above embodiment. According to the present technology, the time when the corporate performance may fluctuate can be more finely managed by performing the user's forecast in a shorter period than the company's plan. For example, when the company's planned values are disclosed on a quarterly basis, the user's forecast may be performed on a monthly basis, and when the company's planned values are disclosed on a monthly basis, the user's forecast may be performed on a weekly basis.

In addition, the number of alerts may be increased or decreased by appropriately changing the threshold setting so that even a small change is not overlooked or only large changes can be noticed.

Besides, the progress of each year for the medium-term plan or long-term plan of corporate performance (hereinafter, also referred to as the medium-term plan, and the like), for example, the management plan within the next 3 to 10 years may be managed and compared with the values predicted by a user during the same period.

If only the company plan of the final year is disclosed in a medium-term plan or the like, the company plan for each year up to the final year may be estimated by any of the following methods or a combination of the following methods.
(1) A company plan for each year is assigned based on an estimation that the sales will increase at a constant growth rate (compound average growth rate CAGR=(1+Y %)\hat{ }(1/X)−1) every year when sales increased by Y % in X years.
(2) A company plan for each year is assigned based on an estimation that the sales will increase by a constant amount every year.
(3) A company plan for each year is assigned based on an estimation that the growth rate of sales will slow down. For example, it is considered that the growth rate will slow down when high growth rate has been maintained recently and the target CAGR is lower than the growth rate.
(4) A company plan for each year is assigned based on an estimation that the growth rate of sales will accelerate. For example, the growth rate is expected to accelerate when the target CAGR is higher than the latest growth rate.
(5) A company plan for each year is assigned based on an estimation that the amount of sales and or the growth rate is calculated by a step function. For example, when a new business is planned to be started from a specific period (or acquisition of external business, sale or withdrawal of existing business, and the like), it is estimated that the amount of the sales or the growth rate will change significantly around that period.
(6) When the profit is planned to change from an actual value of A to B in a medium term, a company plan for each year is assigned by prorating the difference between B and A based on an estimation that the profit will increase by a constant amount every year.
(7) When the profit margin is planned to increase from an actual value of A′% to B′% in a medium term, a company plan for each year is assigned by prorating the difference between B′% and A′% (ppt) based on an estimation that the profit margin will increase at a constant rate every year.
(8) In addition, the estimation may be any one of an estimation based on a value obtained by multiplying the change in sales by a marginal profit ratio, an estimation that the rate of change of profits will accelerate, an estimation that the rate of change of profits will slow down, and an estimation that the values will change due to the start-up of a new business, acquisition, sale, withdrawal, and the like.

### INDUSTRIAL APPLICABILITY

The present technology enables management of a relatively short-term progress of corporate performance with respect to relatively long-term planned values and easy comparison with the predicted values during the same period.

### REFERENCE SIGNS LIST

100 corporate performance forecast management system
110 network
120 server
130 storage device
140, 150 client

1. A corporate performance forecast management system, which is a system for managing forecast of corporate performance and comprising:
a server configured to store planned values of corporate performance in a first period; and
a client configured to send, to the server, user's predicted values of the corporate performance in a second period which is within the first period and shorter than the first period,
wherein the server is configured to calculate planned values of the corporate performance in the second period based on the planned values of the corporate performance in the first period,
compare the planned values of the corporate performance in the second period with the user's predicted values of the corporate performance in the second period, and
send an alert to the client when the planned values of the corporate performance in the second period and the user's predicted values of the corporate performance in the second period deviate from each other by a predetermined value or more.

2. The corporate performance forecast management system according to claim 1,
wherein the corporate performance comprises at least one of the company's sales, operating revenue, gross profit, operating profit, ordinary profit, pre-tax profit, net profit, profit per share, EBIT, EBITDA, and dividend amount.

3. The corporate performance forecast management system according to claim 1,
wherein the first period comprises at least one business year or one fiscal year, and the second period comprises half a year or a quarter.

4. The corporate performance forecast management system according to claim 1,
wherein the first period comprises 3 to 10 business years or 3 to 10 fiscal years, and the second period comprises one business year or one fiscal year.

5. The corporate performance forecast management system according to claim 1,
wherein the planned values of the corporate performance in the second period are the planned values of the corporate performance in the first period prorated according to period.

6. The corporate performance forecast management system according to claim 5,
wherein the values prorated according to period comprise values prorated based on an estimation that the growth rate is constant.

7. The corporate performance forecast management system according to claim 5,
wherein the values prorated according to period comprise values prorated based on an estimation that the growth amount is constant.

8. The corporate performance forecast management system according to claim 5,
wherein the values prorated according to period comprise values prorated based on an estimation that the growth rate will slow down.

9. The corporate performance forecast management system according to claim 5,
wherein the values prorated according to period comprise values prorated based on an estimation that the growth rate will accelerate.

10. The corporate performance forecast management system according to claim 5,
wherein the values prorated according to period comprise values prorated based on an estimation that the amount or the growth rate is calculated by a step function.

11. The corporate performance forecast management system according to claim 5,
wherein the values prorated according to period comprise values prorated based on an estimation that the profit margin will increase at a constant rate.

12. The corporate performance forecast management system according to claim 5,
wherein the values prorated according to period comprise any one of an estimation based on a value obtained by multiplying the change in sales by a marginal profit ratio, an estimation that the rate of change of profits will accelerate, an estimation that the rate of change of profits will slow down, and an estimation that the values will change due to the start-up of a new business, acquisition, sale, withdrawal, and the like.

13. The corporate performance forecast management system according to claim 1,
wherein the planned values of the corporate performance in the second period are the planned values of the corporate performance in the first period prorated according to period and seasonality.

14. The corporate performance forecast management system according to claim 13,
wherein the values prorated according to period and seasonality are values based on the seasonality of the performance of the company over the past several years.

15. The corporate performance forecast management system according to claim 1,
wherein the predetermined value is a predetermined amount or a predetermined rate.

16. The corporate performance forecast management system according to claim 15,
wherein the predetermined amount or the predetermined rate is calculated using any of a standard deviation in the volatility of the performance of the company over the past several years, a fixed amount or rate, and a value or rate set by the user.

17. The corporate performance forecast management system according to claim 1,
wherein the case in which the planned values of the corporate performance in the second period and the user's predicted values of the corporate performance in the second period deviate from each other by a predetermined value or more comprises a case in which the difference between the predicted value and the planned value in two consecutive second periods changes from positive to negative or from negative to positive.

18. The corporate performance forecast management system according to claim 1,
wherein the values predicted by the user comprise values selected by the user from a plurality of values predicted by third parties.

19. The corporate performance forecast management system according to claim 1,
wherein the plurality of values predicted by the third parties comprise the median value or the average value of the plurality of predicted values.

20. The corporate performance forecast management system according to claim 1,
wherein the alert contains the name or identification number of the company and information for specifying the second period.

21. A method for managing forecast of corporate performance, comprising:
receiving planned values of corporate performance in a first period,
calculating planned values of corporate performance in the second period, which is within the first period and shorter than the first period, based on the planned values of the corporate performance in the first period,
receiving the user's predicted values of the corporate performance in the second period,
comparing the planned values of the corporate performance in the second period with the user's predicted values of the corporate performance in the second period, and
sending an alert when the planned values of the corporate performance in the second period and the user's predicted values of the corporate performance in the second period deviate from each other by a predetermined value or more.

22. A computer-readable recording medium which have recorded therein a program that causes a server to execute the following steps, wherein
the server is capable of storing planned values of corporate performance in a first period and receiving user's predicted values of the corporate performance in a second period which is within the first period and shorter than the first period, and wherein
the steps include:
calculating planned values of the corporate performance in the second period, which is within the first period and shorter than the first period, based on the planned values of the corporate performance in the first period,
receiving the user's predicted values of the corporate performance in the second period,
comparing the planned values of the corporate performance in the second period with the user's predicted values of the corporate performance in the second period, and
sending an alert when the planned values of the corporate performance in the second period and the user's predicted values of the corporate performance in the second period deviate from each other by a predetermined value or more.

23. A corporate performance forecast management system, which is a system for managing forecast of corporate performance and comprising:
a server configured to store planned values of corporate performance in a first period, and
a client configured to send, to the server, user's predicted values of corporate performance in a second period which is within the first period and shorter than the first period,
wherein the server is configured to calculate planned values of the corporate performance in the second period based on the planned values of the corporate performance in the first period,
compare the planned values of the corporate performance in the second period with the user's predicted values of the corporate performance in the second period, and
determine that the planned values of the corporate performance in the second period and the user's predicted values of the corporate performance in the second period deviate from each other by a predetermined value or more.

24. A corporate performance forecast management server, which is a server for managing forecast of corporate performance and configured to:
store planned values of corporate performance in a first period,
calculate planned values of the corporate performance in a second period according to a predetermined rule based on the planned values of the corporate performance in the first period, and
determine that the planned values of the corporate performance in the second period differ from the planned values of the corporate performance in a predetermined period different from the second period by a predetermined value or more.

25. A corporate performance forecast management system, which is a system for managing forecast of corporate performance and comprising:
a server configured to store planned values of corporate performance in a first period, and
a client configured to send, to the server, user's predicted values of corporate performance in a second period which is within the first period and shorter than the first period,
wherein the sever calculates planned values of the corporate performance in the second period based on the planned values of the corporate performance in the first period,
the planned values of the corporate performance in the second period are the planned values of the corporate performance in the first period prorated according to period, and
the values prorated according to period include:
(1) values prorated based on an estimation that the growth rate is constant,
(2) values prorated based on an estimation that the growth amount is constant,
(3) values prorated based on an estimation that the growth rate will slow down,
(4) values prorated based on an estimation that the growth rate will accelerate,
(5) values prorated based on an estimation that the amount or the growth rate is calculated by a step function,
(6) values prorated based on an estimation that the profit margin will increase at a constant rate,
(7) values prorated based on an estimation with a value obtained by multiplying the change in sales by a marginal profit ratio,
(8) values prorated based on an estimation that the rate of change of profits will accelerate,
(9) values prorated based on an estimation that the rate of change of profits will slows down, and
(10) values prorated based on an estimation that the values will change due to the start-up of a new business, acquisition, sale, withdrawal, and the like.
